(19) United States
(12) Patent Application Publication
(10) Pub. No.: US 2008/0294496 A1
(43) Pub. Date: Nov. 27, 2008

(54) METHODS, SYSTEMS, AND COMPUTER PROGRAM PRODUCTS FOR AUTOMATING SUPPLY CHAIN PLANNING PROCESSES

(75) Inventors: Thomas M. Hall, New Windsor, NY (US); E. Weston Seaman, Poughkeepsie, NY (US); David Whalen, Middletown, NY (US)

Correspondence Address: CANTOR COLBURN LLP - IBM FISHKILL, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/753,668

(22) Filed: May 25, 2007

(51) Int. Cl. G06F 17/30

(52) U.S. Cl. 705/10

(57) ABSTRACT

Methods, systems, and computer program products for automating supply chain planning processes are provided. A method includes providing a user interface having data fields for receiving product information including projected and actual sales data and finance information from a plurality of entities. The method also includes receiving the projected and actual sales data and finance information via the data fields and storing the projected and actual sales data and finance information in a first database. The method further includes retrieving portions of the projected and actual sales data, for a selected period of time, from the first database in response to a request, and providing a consolidated view of projected and actual sales of products for the selected period of time via the user interface.

### BACKGROUND OF THE INVENTION

The present disclosure relates generally to supply chain management and, in particular, to methods, systems, and computer program products for automating supply chain planning processes for outsourced products.

Convention planning systems, such as Enterprise Resource Planning (ERP), Material Requirements Planning (MRP) and Advanced Planning and Scheduling (APS) are well known in many industries today as useful methods for planning enterprise operations. ERP systems provide a framework that integrates all facets of a business, including planning, manufacturing, supply chain management, sales and marketing. Traditional Material Requirements Planning (MRP) and Manufacturing Resource Planning systems generate requirements for materials, parts, and subassemblies that are established on an organization's Bills of Material (BOMs) for the manufacture of existing products.

One important aspect of such planning systems is Supply Chain Management (SCM). SCM involves the administration of an organization's supply channels, distribution, and transportation resources, including product ordering, fulfillment and replenishment. Effective supply chain management is particularly important to the electronics industry. In today's global economy, particularly with respect to computer technology, life cycles and prices related to electronics such as personal computers, PDAs, cellular telephones, etc., have dramatically declined over the last ten years. Further, the growth of e-commerce on the Internet creates additional pressures on this industry as traditional geographic barriers are broken down and new businesses/competitors are entering the market. In order to stay competitive, these market dynamics require electronics businesses to develop and introduce new products faster and cheaper than the competition. To meet this demand, new and enhanced business solutions are critical.

A popular trend in electronics manufacturing involves contracting out some or all of the manufacturing of a manufacturer's computer products to third party manufacturers which then build these products according to specification. This arrangement, known as outsourcing, creates a process where the original manufacturer (called an Original Equipment Manufacturer, or OEM) buys computers in bulk from third-party contract manufacturers and then customizes them for a particular application. It then markets and sells the customized computers under its own name. By outsourcing the manufacturing and assembly of these goods, established OEMs are able to focus on other business areas such as new product development and customer relationship management. Additionally, as product designs and components are becoming increasingly complex and frequently updated, a contract manufacturer with specialized skills may be better equipped to accommodate the changing technology. By outsourcing to meet peak demands, an OEM may be able to avoid having to build new facilities and/or hire new people.

However, many ERP systems are inefficient in that they lack the ability to exchange vital information across enterprise/business applications and data stores. For example, managing a division's sales and rebates is generally a manual process implemented using spreadsheets. The sales and rebates data are then manually applied to enterprise data produced from, e.g., MRP applications whereby an analyst or group then reviews the two or more sources of data. In addition, such manually implemented spreadsheets are prone to errors.

What is needed, therefore, is an automated and repeatable method for managing enterprise-wide sales and rebates in an outsourced supply chain environment.

### BRIEF SUMMARY OF THE INVENTION

Embodiments of the invention include methods for automating supply chain planning processes. A method includes providing a user interface having data fields for receiving product information including projected and actual sales data and finance information from a plurality of entities. The method also includes receiving the projected and actual sales data and finance information via the data fields and storing the projected and actual sales data and finance information in a first database. The method further includes retrieving portions of the projected and actual sales data, for a selected period of time, from the first database in response to a request, and providing a consolidated view of projected and actual sales of products for the selected period of time via the user interface.

Additional embodiments include systems for automating supply chain planning processes. A system includes a host system executing a planning application. The planning application includes a user interface having data fields for receiving product information including projected and actual sales data and finance information from a plurality of entities. The planning application implements a method. The method includes receiving the projected and actual sales data and finance information via the data fields and storing the projected and actual sales data and finance information in a first database. The method further includes retrieving portions of the projected and actual sales data, for a selected period of time, from the first database in response to a request, and providing a consolidated view of projected and actual sales of products for the selected period of time via the user interface.

Further embodiments include computer program products for automating supply chain planning processes. A computer program product includes instructions for causing a computer to implement a method. The method includes providing a user interface having data fields for receiving product information including projected and actual sales data and finance information from a plurality of entities. The method also includes receiving the projected and actual sales data and finance information via the data fields and storing the projected and actual sales data and finance information in a first database. The method further includes retrieving portions of the projected and actual sales data, for a selected period of time, from the first database in response to a request, and providing a consolidated view of projected and actual sales of products for the selected period of time via the user interface.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a system upon which automated planning processes may be implemented in accordance with exemplary embodiments;

FIG. 2 is flow diagram describing a process for implementing automated planning functions in accordance with exemplary embodiments;

FIG. 3 is a user interface screen illustrating a main menu for accessing the automated planning functions in accordance with exemplary embodiments;

FIG. 4A-4B is a database table illustrating data fields used by a user interface of the automated planning processes in an exemplary embodiment;

FIG. 5 is a user interface screen for generating reports in accordance with exemplary embodiments; and

FIG. 6 is a computer screen window illustrating a sample report generated via the user interface screen shown in FIG. 5 in accordance with exemplary embodiments.

The detailed description explains the preferred embodiments of the invention, together with advantages and features, by way of example with reference to the drawings.

### DETAILED DESCRIPTION OF THE EXEMPLARY EMBODIMENTS

In accordance with exemplary embodiments, automated supply chain planning processes are provided. The exemplary planning processes automate the process for generating buy/sell sales and rebate plans and outlook projections, which are used for financial planning and customer credit approvals. The additional reporting capabilities of the exemplary planning processes enable brand groups to project rebate product savings to increase accuracy as compared to using historical data. The exemplary planning processes manage the business rules and include a web application providing a system-generated methodology for entering and managing projected sales for both product components, assembly level items, and product level sales; loading of predefined sales projections and actual sales via spreadsheets; and reporting capabilities that allow for the sales and rebates to be displayed and analyzed in several views such as division, brand, customers, customer location, product, component, and commodity. Reports also provide comparisons between the plan and outlooks for variance analysis. The exemplary planning processes provide greater efficiencies, accuracy, and reporting capabilities that are not previously available manually due to, e.g., data complexity.

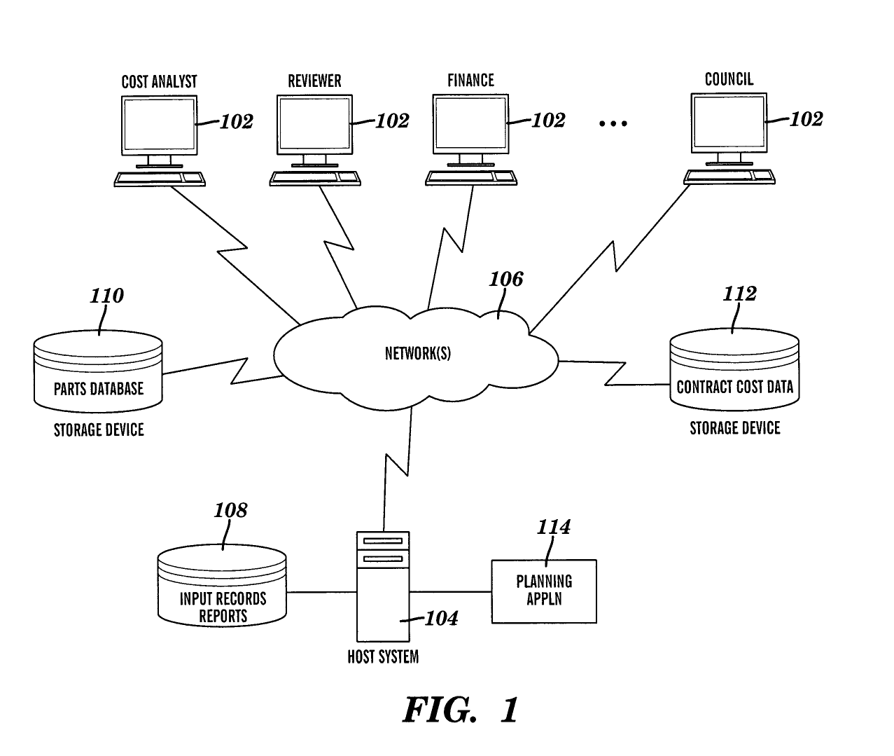

The processes described in FIGS. 1-6 are directed to a computer electronics manufacturing enterprise, it will be understood that the exemplary embodiments are not so limited, but rather any type of industry that manufactures products, e.g., automotive industry, may utilize the automated planning processes described herein.

Referring now to FIG. 1, a system upon which the automated planning processes may be implemented in accordance with exemplary embodiments will now be described. The system of FIG. 1 includes a host system 104 executing computer instructions for performing automated planning functions. As shown in FIG. 1, the host system 104 executes a planning application 114 as will be described further herein. The system of FIG. 1 also includes user systems 102 through which users at one or more geographic locations may contact the host system 104. The user systems 102 are coupled to the host system 104 via one or more network(s) 106. Each user system 102 may be implemented using a general-purpose computer executing a computer program for carrying out the processes described herein. The user systems 102 may be personal computers (e.g., a lap top, a personal digital assistant) or host attached terminals. If the user systems 102 are personal computers, the processing described herein may be shared by a user system 102 and the host system 104 (e.g., by providing an applet to the user system 102).

In an exemplary embodiment, the system of FIG. 1 represents an electronics manufacturing enterprise whereby the host system 104 executes the planning application 114 on behalf of various enterprise entities (i.e., user systems 102). User systems 102 may be operated by one or more cost analysts, reviewers, finance groups, and commodity councils, as will be described further herein.

The network 106 may be any type of known network including, but not limited to, a wide area network (WAN), a local area network (LAN), a global network (e.g. Internet), a virtual private network (VPN), and an intranet. The network 106 may be implemented using a wireless network or any kind of physical network implementation known in the art. A user system 102 may be coupled to the host system through multiple networks (e.g., intranet and Internet) so that not all user systems 102 are coupled to the host system 104 through the same network. One or more of the user systems 102 and the host system 104 may be connected to the network 106 in a wireless fashion. In one embodiment, the network is an intranet and one or more user systems 102 execute a web browser to contact the host system 104 through the network 106. In another exemplary embodiment, the user system 102 is connected directly (i.e., not through the network 106) to the host system 104.

The host system 104 may be directly connected to, or contain, a storage device 108. Storage device 108 may be implemented using a variety of devices for storing electronic information. The storage device 108 is logically addressable as a consolidated data source across a distributed environment that includes a network 106. Information stored in the storage device 108 may be retrieved and manipulated via the host system 104. The storage device 108 houses one or more databases input records and reports generated and managed via the planning application 114. In an exemplary embodiment, the host system 104 operates as a database server and coordinates access to application data including data stored on storage device 108.

The host system 104 depicted in FIG. 1 may be implemented using one or more servers operating in response to a computer program stored in a storage medium accessible by the server. The host system 104 may operate as a network server (e.g., a web server) to communicate with the user systems 102. The host system 104 handles sending and receiving information to and from the user systems 102 and can perform associated tasks. The host system 104 may also include a firewall to prevent unauthorized access to the host system 104 and enforce any limitations on authorized access. For instance, an administrator may have access to the entire system and have authority to modify portions of the system. A firewall may be implemented using conventional hardware and/or software as is known in the art.

The host system 104 may also operate as an application server. The host system 104 executes one or more computer programs to provide automated supply chain management planning functions (e.g., planning application 114). In addition, the host system 104 may be executing one or more business applications in support of the planning processes, such as a spreadsheet application, an ERP suite of applications, and other tools typically found in a manufacturing enterprise environment. Processing may be shared by the user system 102 and the host system 104 by providing an application (e.g., java applet) to the user system 102. Alternatively, the user system 102 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

The planning application 114 includes a user interface for enabling users of user systems 102 to enter data used by the application 114. The user interface includes several data fields relating to projected and actual sales data, finance information, and commodity council information as described further herein. In addition, the planning application 114 is in communication with a variety of data sources and applications for extracting data generated and stored in external locations. As shown in FIG. 1, e.g., external data sources 110 and 112 are in communication with the host system 104 via network 106. Data source 110 may be a global data storage device that houses parts and component data for products and/or assemblies manufactured by the host system 104 enterprise and/or its contract manufacturers in an outsourced arrangement. Data source 112 may be a global storage device that houses contract information between the host system 104 enterprise (e.g., OEM) and its suppliers/contract manufacturers with respect to costs of components/assemblies purchased by the host system 104 enterprise. The host system 104 utilizes a software application (e.g., a plug-in application or by logic incorporated into the planning application 114) that extracts data from data sources 110 and 112 (e.g., part number data from data source 110) and pricing data from data source 112 (e.g., procurement commodity management system data via a business data warehouse). By way of non-limiting examples, the data source 110 may be implemented using, e.g., 12 eXplore™ and the data source 112 may be implemented using, e.g., IBM's® DB2 database management system. The data from data sources 110 and 112 are extracted and ported for use by the planning application 114.

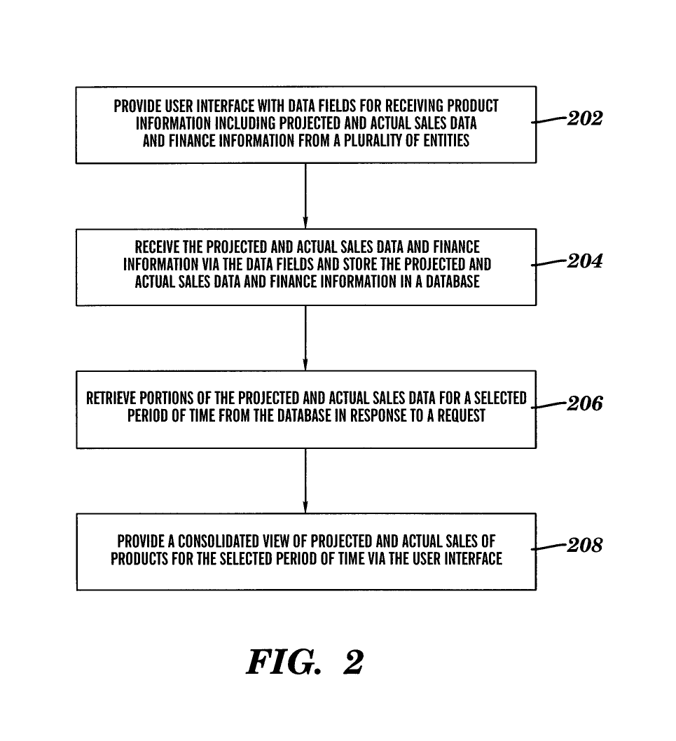

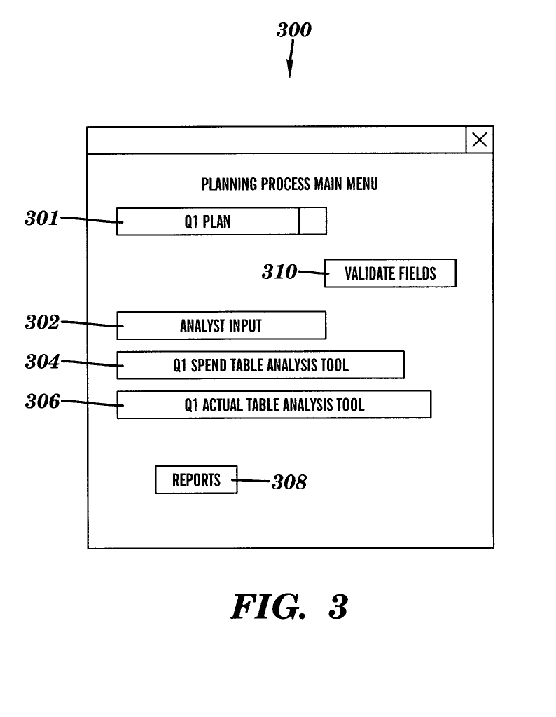

Turning now to FIG. 2, an exemplary process for implementing the automated planning processes will now be described. The planning application 114 includes a user interface having data fields for receiving product information including projected and actual sales data and finance information from a plurality of entities (e.g., user systems 102). An exemplary user interface screen and main menu for entering the product information is shown and described in FIG. 3.

The main menu screen of FIG. 3 includes options for entering projected sales information, reviewing the entered projected sales information for accuracy and approval, entering actual sales information, and reporting. The user interface of the planning application 114 provides restricted access to the aforementioned options based upon a user role. For example, a cost analyst may select ANALYST INPUT option 302, which will allow access to a “sandbox” area for entering product information. However, the cost analyst may not have access to other options 304-308. A cost analyst may be a representative of a particular division of the business enterprise that specializes in procurement activities.

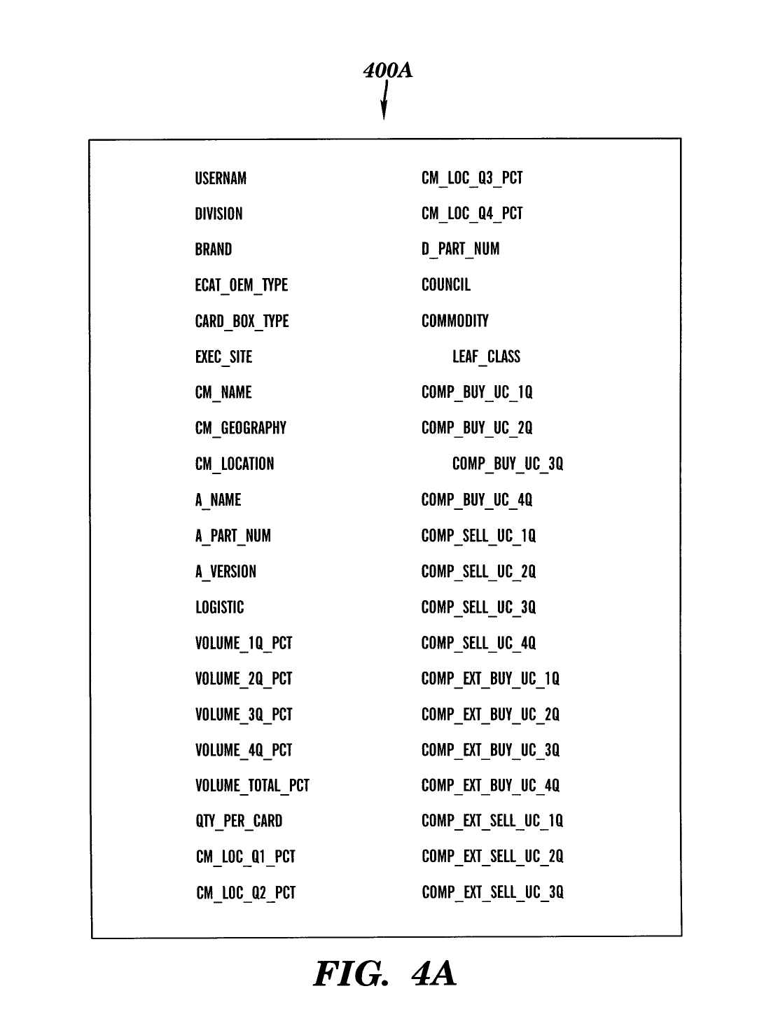

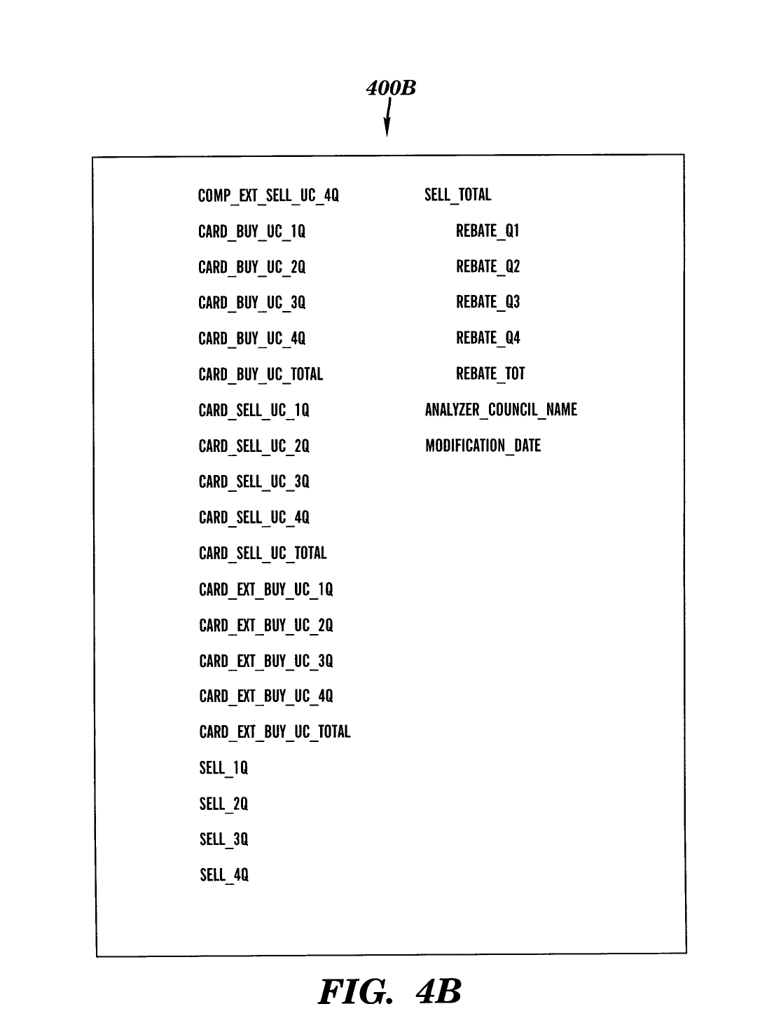

As shown in the user interface screen 300 of FIG. 3, users may enter or select options based upon a time period, e.g., quarterly. The time period may be selected by a drop down option 301. Upon selecting the time period via option 301 and the ANALYST INPUT option 302, the planning application 114 redirects the user to a new interface screen (not shown) for entering projected sales data for the selected time period. The user interface screen for entering projected sales data includes various data fields for receiving and classifying the projected sales data entered. The projected sales data may be entered by a cost analyst for each product division of an enterprise and includes projected requirements for products to be manufactured. The projected requirements include product component data, sourcing data, and projected product component quantities. A database table illustrating these and other data fields used by the planning application 114 is shown in FIG. 4.

In addition to the component level information entered by a cost analyst, the planning application 114 may further enable projected sales data to be entered by commodity council members (e.g., via council user system 102) for each commodity type of the business enterprise. The projected sales data may include product-level requirements, sourcing data, and quantities of products to be manufactured.

The database table 400A-400B enables each cost analyst for the entire business enterprise to enter projected sales data at the component level, as well as council members to enter projected sales data on a product level. Once the cost analyst completes entry of the data fields in the user interface screen, the planning application 114 generates and stores an input record. One input record is generated and stored for each cost analyst. The input records may be stored in storage device 108.

As shown in table 400A-400B, data fields enable a great deal of information to be captured by the planning application 114. Selected data fields provided in table 400A-400B will now be described in an exemplary embodiment. EXEC_SITE refers to the OEM (e.g., host system 104 enterprise) executing the purchase orders. A_NAME refers to the name of a product manufactured by the enterprise. LOGISTIC refers to the process used to purchase the components (e.g., sourcing strategy). VOLUME_#Q_PCT refers to the quantity of components to be purchased for a given quarter. CM_LOC_Q#_PCT refers to an award percentage of the business to the contract manufacturer for a given quarter. This could be multiple sources, or contract manufacturers. D_PART_NUM refers to a component part number. COMP_BUY_UC_#Q refers to the price the enterprise (e.g., host system 104 enterprise) pays to purchase the component for the given time period. COMP_SELL_UC_#Q refers to the selling price of the component used by the enterprise for a given quarter. COMP_EXT_BUY_UC_#Q refers to the price the enterprise pays for all of the components for a given product for a given quarter. COMP_EXT_SELL_UC_#Q refers to the selling price the enterprise applies for all of the components for a given product for a given time period. CARD_BUY_UC refers to the price the enterprise pays to purchase all of the components for a product (no time measure). CARD_SELL_UC refers to the selling price the enterprise uses to sell all the components of a product (no time measure). SELL_#Q refers to the current selling price of the product by the enterprise for a given quarter. REBATE_#Q refers to the savings rebate to the enterprise brand for the product for a given quarter. ANALYZERCOUNCIL_NAME refers to the buyer that entered the product information into the planning application 114 (e.g., cost analyst). MODIFICATION_DATE refers to the last date a change was made to an input record.

Returning now to FIG. 2, a reviewer may access the input records created by the cost analyst and determine whether to accept, reject, or modify the entries. This may be implemented by selecting Q1 SPEND TABLE ANALYSIS TOOL option 304 on main menu screen 300. The reviewer may be a representative of the business enterprise of host system 104 who is in a supervisory position to the cost analyst. In addition, an option VALIDATE FIELDS 310 may be selected whereby the planning application 114 reviews each of the entries in the input record to determine whether the record is complete and accurate. In addition, a reviewer may modify the data entered in input records via, e.g., the MODIFICATION_DATE field which is provided as one of the data fields illustrated in FIG. 4. Modifications may be made and subsequent updated reports may be generated to reflect the modifications as described further herein.

Further actual sales data is also entered by a user system 102. Actual sales data may be entered by a member of a finance group or department of the business enterprise by selecting Q1 ACTUAL TABLE ANALYSIS TOOL option 306. The types of information entered by a member of the finance group via user system 102 includes sales information classified by e.g., enterprise division, enterprise brand, and contract manufacturer, contract manufacturer location for each product sold. In addition, finance group members may enter current selling prices for products sold. As indicated above, the planning application 114 extracts various information from external data sources. In an exemplary embodiment, the planning application 114 extracts current contract component costs for purchasing a product component by the business enterprise of host system 104. The current contract component costs may be extracted from storage device 112. The planning application 114 determines the percentage uplift from the current contract component costs to set the current selling prices.

Turning back to FIG. 2, the planning application 114 receives the projected and actual sales data and finance information via the data fields and stores the projected and actual sales data and finance information in a database (e.g., input records in storage device 108) at step 204.

The planning application 114 also gathers information from external data sources (e.g., storage devices 110 and 112). For example, the planning application 114 may extract parts data from storage device 110 and contract cost data from storage device 112 as described above.

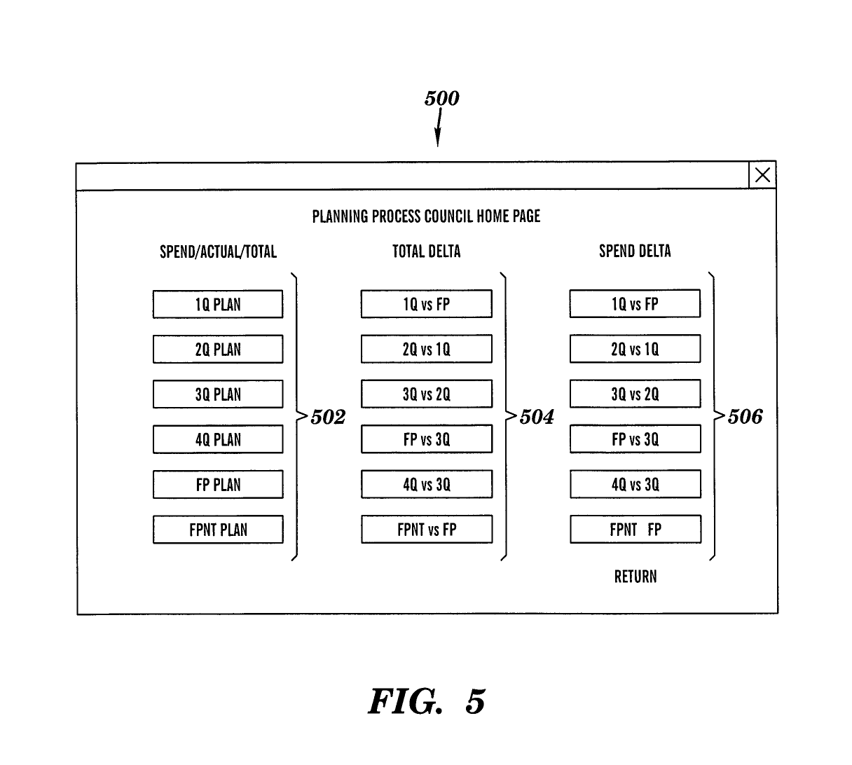

Thus configured, the input records stored in storage device 108 may be searched by various data fields and a variety of reports may be generated. Reports, or views, may be generated via a user interface screen of the planning application 114. For example, an authorized user (e.g., commodity council user system 102) may select option 308 on main menu screen 300 and a user interface screen 500 as shown in FIG. 5 is presented to the user. At step 206, upon a request to generate a report is entered by the user via the user interface screen 500.

At step 208, the planning tool 114 retrieves portions of the projected and actual sales data, for a selected period of time, from the input records of the storage device 108.

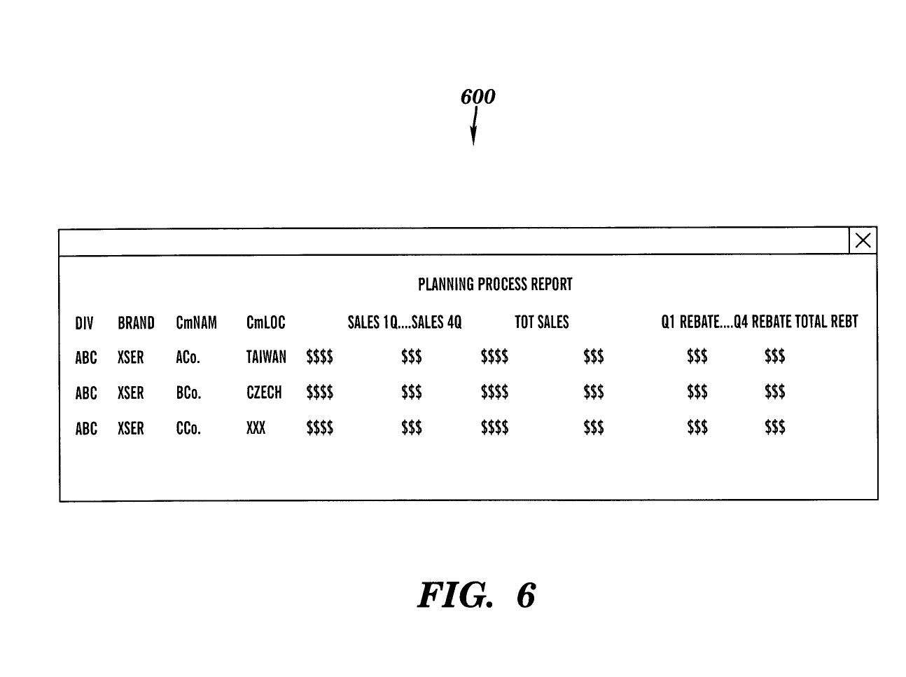

At step 210, the planning application 114 provides a consolidated view of the projected and actual sales of products for the selected time period via the user interface. A sample view 600 is shown in FIG. 6. The output reports enabled by the planning application provide views by data fields, such as, execution site of the enterprise executing purchase orders for the products and product components; product division of the enterprise; product brand; contract manufacturer of the enterprise; contract manufacturer site location; and geography.

In addition, comparison reports may be generated by the planning application 114 for selected time periods. For example, a comparison view may be generated by: projected sales data for two consecutive time periods (e.g., first and second quarters) (e.g., via one of options 502 of FIG. 5); actual sales data for two consecutive time periods (via one of options 502 of FIG. 5); differences in projected sales between two consecutive time periods represented as a percentage (via, e.g., one of options 504 of FIG. 5; differences in actual sales between two consecutive time periods represented as a percentage (via, e.g., one of options 504 of FIG. 5); differences in projected sales between two consecutive time periods represented in dollars (via, e.g., one of options 506 of FIG. 5); and differences in actual sales between two consecutive time periods represented in dollars (via, e.g., one of options 506 of FIG. 5).

Further, reports may be generated to reflect updates or modifications made to input records. For example, a user may enter modifications to an input record via option 304 or 306, followed by selecting reporting option 308 of main menu screen 300. The planning tool presents the user interface 500 to the user and the user may select any of the options therein depending upon the time period to be reviewed/updated.

Comparison reports provide a business enterprise with a comprehensive view of projected and actual sales data over various selected time periods. For example, a council member who accesses user interface screen 500 and selects a current quarter (e.g., third quarter) via option 502, the planning application 114 will generate a view displaying actual sales data for the first and second (previous) quarters and projected sales data for the third and fourth quarters. Thus, the data may be viewed in a variety of ways for easy and effective comparison and analysis of the selected data.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for automating supply chain planning processes, comprising:
providing a user interface having data fields for receiving product information including projected and actual sales data and finance information from a plurality of entities;
receiving the projected and actual sales data and finance information via the data fields and storing the projected and actual sales data and finance information in a first database;
retrieving portions of the projected and actual sales data, for a selected period of time, from the first database in response to a request; and
providing a consolidated view of projected and actual sales of products for the selected period of time via the user interface.

2. The method of claim 1, wherein the projected sales data is received from cost analysts for each product division of an enterprise and includes projected requirements for products to be manufactured, the projected requirements including product component data, sourcing data, and product component quantities.

3. The method of claim 1, wherein the actual sales data is received from finance groups of an enterprise and includes product component descriptions, product component identifiers, and revenue received for each product component sold.

4. The method of claim 3, further comprising:
receiving current selling prices for product components from the finance groups;
receiving current contract component costs for purchasing the product components from a second database; and
determining the percentage uplift from the current contract component costs to set the current selling prices.

5. The method of claim 1, wherein the projected sales data is received from commodity councils for each commodity type of an enterprise, the projected sales data includes product-level requirements, sourcing data, and quantities of products to be manufactured.

6. The method of claim 1, wherein the data fields include at least one of:
execution site of an enterprise executing purchase orders for the products and the product components;
product division of the enterprise;
product brand;
contract manufacturer of the enterprise;
contract manufacturer site location; and
geography;
wherein the view is displayed via at least one of the data fields.

7. The method of claim 1, wherein providing a view includes displaying a comparison view including at least one of:
projected sales data for two consecutive time periods;
actual sales data for two consecutive time periods;
difference in projected sales between two consecutive time periods represented as a percentage;
difference in actual sales between two consecutive time periods represented as a percentage;
difference in projected sales between two consecutive time periods represented in dollars; and
difference in actual sales between two consecutive time periods represented in dollars.

8. The method of claim 1, wherein the user interface includes an option to modify previously entered projected sales data.

9. A system for automating supply chain planning processes, comprising:
a host system; and
a planning application executing on the host system, the planning application including a user interface having data fields for receiving product information including projected and actual sales data and finance information from a plurality of entities, the planning application implementing a method, comprising:
receiving the projected and actual sales data and finance information via the data fields and storing the projected and actual sales data and finance information in a first database;
retrieving portions of the projected and actual sales data, for a selected period of time, from the first database in response to a request; and
providing a consolidated view of projected and actual sales of products for the selected period of time via the user interface.

10. The system of claim 9, wherein the projected sales data is received from cost analysts for each product division of an enterprise and includes projected requirements for products to be manufactured, the projected requirements including product component data, sourcing data, and product component quantities.

11. The system of claim 9, wherein the actual sales data is received from finance groups of an enterprise and includes sales data classified by at least one of enterprise division, enterprise brand, contract manufacturer, and contract manufacturer location for each product sold; and
wherein current selling prices for products sold is received from the finance groups of the enterprise.

12. The system of claim 11, wherein the planning application further performs:
receiving current selling prices for product components from the finance groups;
receiving current contract component costs for purchasing the product components from a second database; and
determining the percentage uplift from the current contract component costs to set the current selling prices.

13. The system of claim 9, wherein the projected sales data is received from commodity councils for each commodity type of an enterprise, the projected sales data including product-level requirements, sourcing data, and quantities of products to be manufactured.

14. The system of claim 9, wherein the data fields include at least one of:
execution site of an enterprise executing purchase orders for the products and the product components;
product division of the enterprise;
product brand;
contract manufacturer of the enterprise;
contract manufacturer site location; and
geography;
wherein the view is displayed via at least one of the data fields.

15. The system of claim 9, wherein providing a view includes displaying a comparison view including at least one of:
projected sales data for two consecutive time periods;
actual sales data for two consecutive time periods;
difference in projected sales between two consecutive time periods represented as a percentage;
difference in actual sales between two consecutive time periods represented as a percentage;
difference in projected sales between two consecutive time periods represented in dollars; and
difference in actual sales between two consecutive time periods represented in dollars.

16. The system of claim 9, wherein the user interface includes an option to modify previously entered projected sales data.

17. A computer program product for automating supply chain planning processes, the computer program product including instructions for causing a computer to implement a method, comprising:
providing a user interface having data fields for receiving product information including projected and actual sales data and finance information from a plurality of entities;
receiving the projected and actual sales data and finance information via the data fields and storing the projected and actual sales data and finance information in a first database;
retrieving portions of the projected and actual sales data, for a selected period of time, from the first database in response to a request; and
providing a consolidated view of projected and actual sales of products for the selected period of time via the user interface.

18. The computer program product of claim 17, wherein the projected sales data is received from cost analysts for each product division of an enterprise and includes projected requirements for products to be manufactured, the projected requirements including product component data, sourcing data, and product component quantities.

19. The computer program product of claim 17, wherein the actual sales data is received from finance groups of an enterprise and includes product component descriptions, product component identifiers, and revenue received for each product component sold.

20. The computer program product of claim 19, further comprising instructions for implementing:
receiving current selling prices for product components from the finance groups;
receiving current contract component costs for purchasing the product components from a second database; and
determining the percentage uplift from the current contract component costs to set the current selling prices.
